(19) United States
(12) Patent Application Publication
(10) Pub. No.: US 2019/0063655 A1
(43) Pub. Date: Feb. 28, 2019

(54) QUICK CONNECTOR

(71) Applicants: Huangyao Hong, Quanzhou, FJ (CN); Quanzhou Lianchuang Kitche&Bathroom Co., Ltd., Quanzhou (CN)

(72) Inventor: Wenfan Chen, Quanzhou (CN)

(21) Appl. No.: 15/987,111

(22) Filed: May 23, 2018

(30) Foreign Application Priority Data
Aug. 31, 2017 (CN) 201721104259.6

(51) Int. Cl. F16L 37/12

(52) U.S. Cl. CPC F16L 37/1215

(57) ABSTRACT

A quick connector includes a sleeve, a first, second inner threaded portion, a rubber washer, a spring, a connecting piece, an annular base, a first, second stopping block, a piece, a groove, and a latch. The annular base is arranged on a bottom portion of the sleeve. The first, second stopping blocks are arranged on two sides of the inner wall of the sleeve, respectively. The first, second inner threaded portions are arranged on one side of the first, second stopping blocks, respectively. Tire rubber washer is arranged on both a top portion of the first, second inner threaded portions. An inner wall of the sleeve defines the groove. The connector solves the inefficiency and inconvenience of conventional installations, especially the installation or maintenance of the kitchen faucet and the cabinet faucet, which is easy and quick and brings convenience to people.

### CROSS REFERENCE TO RELATED APPLICATIONS

The present application claims the benefit of Chinese Patent Application No. 201721104259.6 filed on Aug. 31, 2017. The above is hereby incorporated by reference.

### TECHNICAL FIELD

The subject matter herein generally relates to field of connectors, in particular to a quick connector.

### BACKGROUND

The daily use of our traditional connector products in real life has great deficiencies. We have carried out in-depth thinking and research to achieve technical improvements and function surpassing. We solved the inefficiencies and inconveniences that have occurred in conventional installations, especially the installation or maintenance of the kitchen faucet and cabinet faucet. Due to the harsh environment caused by the sewage pipe during use, the use of traditional connectors may appear to not align to the upper screw thread or may consume quite a bit of time to screw the connector to the kitchen faucet or cabinet faucet. Small operating space of the kitchen bathroom may aggravate the difficulties such installation and maintenance work. All these problems can be painful and inconvenient to people.

### SUMMARY

The present disclosure aims to overcome the problems existing in the background, and the present disclosure provides a quick connector to solve the problem mentioned above.

For solving the problem mentioned above, the present disclosure provides the following technology.

The present disclosure provides a quick connector. The quick connector comprises a sleeve, a first inner threaded portion, a second inner threaded portion, a rubber washer, a spring, a connecting piece. The sleeve, the first threaded portion and the second threaded portion, the rubber washer, the spring, and the connecting piece are assembled in sequence. The sleeve comprises a hollow shaft with a head on a first end. The head is annular and at least partially extends towards the interior of the hollow shaft radially and forms a shoulder and an opening with a smaller radius than the hollow shaft. A first stopping block and a second stopping block are located on the shoulder towards to the second end of the sleeve which is opposite to the first end of the sleeve, and therefore form two receiving parts for receiving the first and second inner threaded portions. When the first and second inner threaded portions are fitted into the receiving parts, the rubber washer is arranged on the first inner threaded portion and the second inner threaded portion in a direction of the axis of the hollow shaft. The spring is arranged on a side of the rubber washer away from the first and second inner threaded portions. The connecting piece is arranged to abut against the spring. The connecting piece comprises a flange for abutting against the spring and fitting into the hollow shaft of the sleeve. The flange comprises a protrusion arranged on an outer wall of the flange. An inner wall of the hollow shaft of the sleeve defines a slot for receiving the protrusion. The protrusion fits with the slot.

In some embodiments of the present disclosure, the quick connector comprises two protrusions and two slots. The two protrusions are oppositely arranged on the outer wall of the flange of the connecting piece, and the two slots are defined on the inner wall of the hollow shaft of the sleeve. The two protrusions fit with the two slots, respectively.

In some embodiments of the present disclosure, the first inner threaded portion and the second inner threaded portion are located on the two receiving parts formed on the shoulder of the sleeve, respectively. The rubber washer and the spring are placed in turn within the sleeve.

In some embodiments of the present disclosure, both the first inner threaded portion and the second inner threaded portion are made out of copper or other rubber materials; and both the first inner threaded portion and the second inner threaded portion comprise an internal thread.

In some embodiments of the present disclosure, the connecting piece is fixed to the sleeve through the protrusion and the slot.

In some embodiments of the present disclosure, both the sleeve and the connecting piece are made out of APS (Aluminum Profiles) material.

The present disclosure has beneficial effects as follows: the device is a quick connector. Screw thread separation, spring advancement, and taper contraction principle are used to enable screw thread to be instantaneously expanded no matter how long the screw thread is. The quick connecting effect can be achieved once the quick connector is pushed and rotated in place This connector solves the inefficiency and inconvenience of conventional installations, especially the installation or maintenance of the kitchen faucet and cabinet faucet; it is easy and quick to bring convenience to people.

### BRIEF DESCRIPTION OF THE DRAWINGS

Implementations of the present technology will now be described, by way of example only, with reference to the figures.

FIG. 1 is an exploded, isometric view of one exemplary embodiment of the present disclosure.

FIG. 2 is a side view of a sleeve of FIG. 1.

FIG. 3 is a structure diagram of the sleeve of FIG. 1.

FIG. 4 is a structure diagram of a rubber washer of FIG. 1.

FIG. 5 is a diagram of the sleeve of FIG. 1 showing a receiving part.

FIG. 6 is a diagram of an inner threaded portion.

FIG. 7 is a cross-sectional diagram of the sleeve of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series and the like.

The present disclosure described in relation to a quick connector.

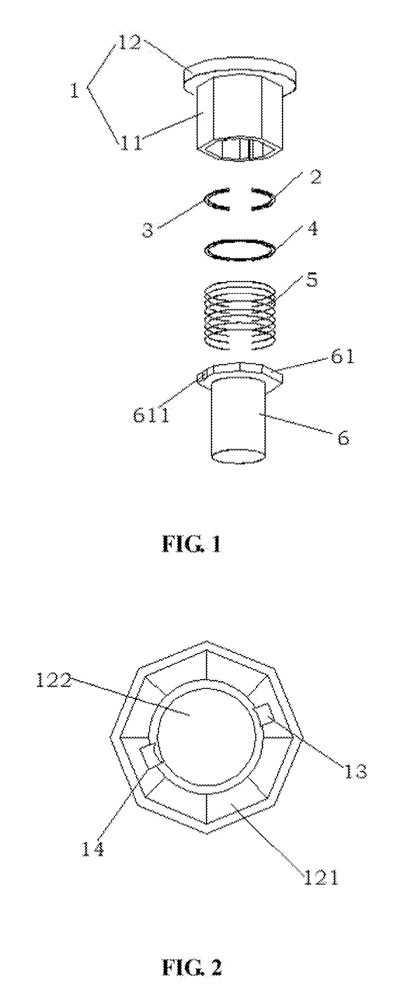

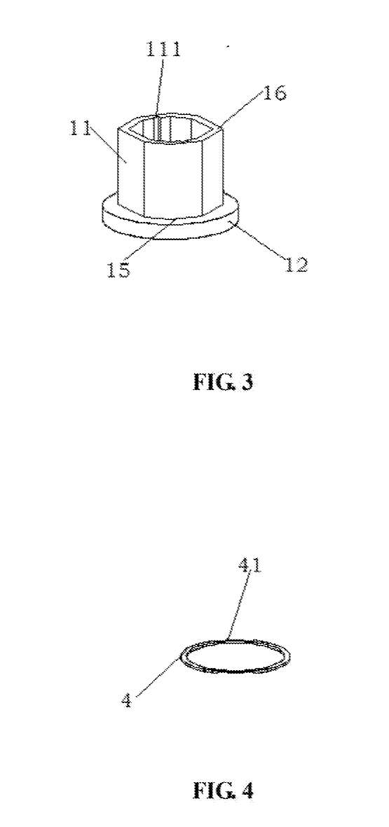

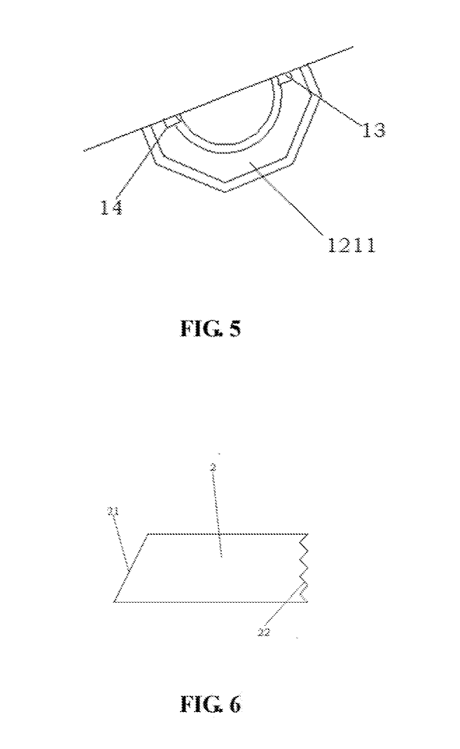

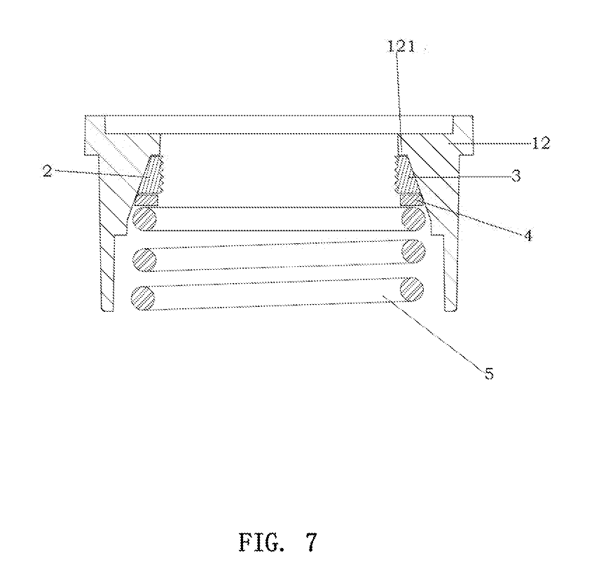

FIGS. 1-6 illustrate that the present disclosure discloses a quick connector. The quick connector comprises a sleeve 1, a first inner threaded portion 2, a second inner threaded portion 3, a rubber washer 4, a spring 5, and a connecting piece 6. The sleeve 1, the first inner threaded portion 2, the second inner threaded portion 3, the rubber washer 4, the spring 5, and the connecting piece 6 are assembled in sequence. The sleeve 1 comprises a hollow shaft 11 with a head 12 on a first end 15. The hollow shaft 11 comprises a tapered inner wall gradually narrowing from a direction approaching the head 12. The head 12 is annular and at least partially extends towards the interior of the hollow shaft 11 radially and forms a shoulder 121 and an opening 122 with a smaller radius than the hollow shaft 11. A first stopping block 13 and a second stopping block 14 are located on the shoulder 121 towards to the second end 16 which is opposite to the first end of the sleeve 1, and therefore form two receiving parts 1211, as shown in FIG. 5, for receiving the first inner threaded portion 2 and the second inner threaded portion 3. When the first inner threaded portion 2 and the second inner threaded portion 3 are fitted into the receiving parts 1211, the rubber washer 4 is arranged on the first inner threaded portion 2 and the second inner threaded portion 3 in the direction of the axis of the hollow shaft 11. The spring 5 is arranged on the side of the rubber washer 4 away from the inner threaded portions. The connecting piece 6 is arranged to abut against the spring 5. The connecting piece 6 comprises a flange 61 for abutting against the spring 5 and fitting into the hollow shaft 11 of the sleeve 1. The flange 61 comprises a protrusion 611 arranged on an outer wall of the flange 61 of the connecting piece 6. An inner wall of the hollow shaft 11 of the sleeve 1 defines a slot 111 for receiving the protrusion 611. The protrusion 611 fits with the slot 111. In some embodiments, the rubber washer 4 further comprises a notch 41. Two notches 41 are shown in FIG. 4.

In at least one exemplary embodiment, the quick connector comprises two protrusions 611 and two slots 111. The two protrusions 611 are oppositely arranged on the outer wall of the flange 61 of the connecting piece 6, respectively, and the two slots 111 are defined on the inner wall of the sleeve 1. The two protrusions 611 are fitted with the two slots 111, respectively.

The first inner threaded portion 2 and second inner threaded portion 3 are fixed on two sides of the inner wall of the sleeve 1, respectively. The rubber washer 4 and the spring 5 are placed in turn within sleeve 1.

Both the first inner threaded portion 2 and the second inner threaded portion 3 are made out of copper or other rubber materials. Both the first inner threaded portion 2 and the second inner threaded portion 3 comprise an internal thread for engaging with an external tooth of a screw tube.

The connecting piece 6 is fixed to the sleeve 1 through the protrusion 611 and the slot 111.

Both the sleeve 1 and the connecting piece 6 can be made out of APS material.

The device is a quick connector, which comprises the sleeve 1, the first inner threaded portion 2, the second inner threaded portion 3, the rubber washer 4, the spring 5, the connecting piece 6, the head 12, the first stopping block 13, the slot 111, the protrusion 611, and the second stopping block 14. The sleeve 1 comprises a tapered inner wall gradually narrowing from the direction that the connecting piece 6 is inserted. The first inner threaded portion 2 and the second inner threaded portion 3 each has a tapered outer wall. When the first inner threaded portion 2 and the second inner threaded portion 3 are placed in the inner of the sleeve 1, respectively and oppositely, the tapered outer wall of the first inner threaded portion 2 or second inner threaded portion 3 faces to the tapered inner wall of the sleeve 1. The rubber washer 4 is placed on the first inner threaded portion 2 and the second inner threaded portion 3 along an axis of the sleeve 1 when the first inner threaded portion and the second inner threaded portion 3 are in place. The spring 5 is placed in the inner of the sleeve 1 and one side of the spring 5 is abutted against one side of the rubber washer 4. The other side of the spring 5 is abutted against to the connecting piece 6 which is fitted into the sleeve 1 through the protrusion 611 and the slot 111. When in use, a screw tube is inserted from the opening 122 of the sleeve 1, and the external tooth of the screw tube contacts the internal thread of the first and second inner threaded portions. The contact of the screw tube and the inner threaded portions may press the spring 5. Rotate the connecting piece 6, and the external tooth of the screw tube will engage with the internal thread of the first inner threaded portion 2 and the second inner threaded portion 3. Release the connecting piece 6, and the spring 5 will revert rapidly to its original position, and therefore press the rubber washer 4 and then the first inner threaded portion 2 and the second inner threaded portion 3, so that the tapered outer wall of the first and second inner threaded portions can be abutted against to the tapered inner wall of sleeve 1. By this way, the external tooth of a screw tube inserting into the sleeve 1 from a direction opposite to the connecting piece 6 can be engaged with the first and second inner thread portions when the quick connector is being used. To be noted, the screw tube may be, for example, an inlet end of a faucet or the like.

The beneficial effect achieved by the present disclosure is that the device is a quick connector. The screw thread separation, the spring advancement, and the taper contraction principle are used to enable the screw thread to be instantaneously expanded no matter how long the screw thread is. Push in place, it is tight immediately once being rotated, and quick connecting effect can be achieved. This connector solves the inefficiency and inconvenience of conventional installations, especially the installation or maintenance of the kitchen faucet and cabinet faucet. It is easy and quick to bring convenience to people.

The exemplary embodiments shown and described above are only examples. Many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will, therefore, be appreciated that the exemplary embodiments described above may be modified within the scope of the claims.

What is claimed is:

1. A quick connector, comprising:
a sleeve comprising a hollow shaft with a head on a first end of the hollow shaft, wherein the head comprises an opening and a shoulder;
a first inner threaded portion and a second inner threaded portion oppositely placed on the shoulder of the sleeve;
a rubber washer located adjacent the first inner threaded portion and the second inner threaded portion;
a spring located abutted against the rubber washer away from the first inner threaded portion and the second inner threaded portion;
a connecting piece abutted against the spring away from the rubber washer.

2. The quick connector from claim 1, wherein the hallow shaft comprises a tapered inner wall gradually narrowing from a direction approaching the head; the first inner threaded portion and the second inner threaded portion each comprise a tapered outer wall and an internal thread; wherein the tapered outer wall is tapered in an opposite direction than the tapered inner wall of the hollow shaft so that the tapered outer wall is abutted against the tapered inner wall of the hollow shaft.

3. The quick connector from claim 1, wherein the first inner threaded portion and the second inner threaded portion are made of copper or rubber.

4. The quick connector from claim 1, wherein the connecting piece comprises a flange for abutting against the spring and fitting into the hollow shaft of the sleeve.

5. The quick connector from claim 4, wherein the flange comprises a protrusion arranged on an outer wall the flange, and an inner wall of the hollow shaft comprises a slot for receiving the protrusion; the coupling of the protrusion and the slot enables the connecting piece to rotate the sleeve.

6. The quick connector from claim 1, wherein a first stopping block and a second stopping block are located on the shoulder towards to a second end of the sleeve, and therefore form two receiving parts on the shoulder for receiving the first inner threaded portion and the second inner threaded portion; wherein the second end of the sleeve is opposite to the first end of the sleeve.

7. The quick connector from claim 1, the sleeve and the connecting piece are made of aluminum profiles.
